(19) United States
(12) Patent Application Publication
(10) Pub. No.: US 2012/0106312 A1
(43) Pub. Date: May 3, 2012

(54) OPTICAL PICKUP DEVICE

(75) Inventor: Kenji Nagatomi, Kaizu-City (JP)

(73) Assignee: Sanyo Electric Co., Ltd., Moriguchi-shi (JP)

(21) Appl. No.: 13/284,462

(22) Filed: Oct. 28, 2011

(30) Foreign Application Priority Data
Oct. 28, 2010 (JP) 2010-242790

(51) Int. Cl. G11B 7/1374

(52) U.S. Cl. 369/112.23; G9B/7.121

(57) ABSTRACT

A first laser light source emits first laser light of a predetermined wavelength, and a second laser light source emits second laser light of a wavelength different from the wavelength of the first laser light. Reflected light of the first and second laser light is entered into an astigmatism portion. The astigmatism portion generates first and second focal lines. A light separating portion separates light fluxes of the reflected light of the first and second laser light from each other, the light fluxes obtained by dividing the reflected light of the first and second laser light into four light fluxes. The light separating portion is constituted of at least one prism having plural slopes, and the photodetector is provided with a common sensor portion which receives the light fluxes of the reflected light of the first and second laser light.

This application claims priority under 35 U.S.C. Section 119 of Japanese Patent Application No. 2010-242790 filed Oct. 28, 2010, entitled “OPTICAL PICKUP DEVICE”. The disclosure of the above application is incorporated herein by reference.

### BACKGROUND OF THE INVENTION

1. Technical Field of the Invention

The invention relates to an optical pickup device, and more particularly to a device suitable for use in irradiating a recording medium having plural laminated recording layers with laser light.

2. Disclosure of Related Art

In recent years, the number of recording layers has been increasing in accordance with a demand for an increase in the data capacity of an optical disc. The data capacity of a disc can be remarkably enhanced by forming plural recording layers in the disc. In the case where recording layers are laminated, generally, two layers are formed on one side of a disc. In recent years, however, a disc having three or more recording layers on one side thereof has been put into practical use in order to further increase the data capacity. An increase in the number of laminated recording layers enables to increase the data capacity of a disc. An increase in the number of laminated recording layers, however, may narrow the interval between the recording layers, and increase signal degradation resulting from an interlayer crosstalk.

As the number of recording layers to be laminated is increased, reflection light from a recording layer (a targeted recording layer) to be recorded/reproduced is reduced. As a result, if unwanted reflection light (stray light) is entered into a photodetector from a recording layer on or under the targeted recording layer, a detection signal may be deteriorated, which may adversely affect focus servo control and tracking servo control. In view of this, in the case where a large number of recording layers are laminated, it is necessary to properly remove stray light, and stabilize a signal from a photodetector.

Japanese Unexamined Patent Publication No. 2009-211770 (corresponding to U.S. Patent Application Publication No. US2009/0225645 A1) discloses a novel arrangement of an optical pickup device operable to properly remove stray light, in the case where a large number of recording layers are formed. With this arrangement, it is possible to form an area where only signal light exists, on a light receiving surface of a photodetector. By disposing a sensor of the photodetector in the above area, it is possible to suppress an influence on a detection signal resulting from stray light.

In the optical pickup device, in the case where a reading operation or a writing operation is performed for recording media of different types, for instance, lasers for emitting laser light in correspondence to the recording media are disposed in the optical pickup device. The laser light emitted from each of the lasers is irradiated onto a corresponding recording medium, and reflected light reflected on the recording medium is guided to a photodetector by a common optical system. In this case, since it is necessary to provide a sensor portion which receives laser light in correspondence to each of the recording media, the size of the photodetector maybe increased. The increase in the size of the photodetector makes it difficult to miniaturize the optical pickup device.

### SUMMARY OF THE INVENTION

An optical pickup device according to a main aspect of the invention includes a first laser light source which emits first laser light of a predetermined wavelength; a second laser light source which emits second laser light of a wavelength different from the wavelength of the first laser light; an optical element which aligns optical axes of the first and second laser light with each other; an objective lens portion which focuses the first and second laser light on a recording medium; an astigmatism portion into which reflected light of the first and second laser light reflected on the recording medium is entered, and which generates a first focal line by converging the reflected light in a first direction and generates a second focal line by converging the reflected light in a second direction perpendicular to the first direction; a light separating portion which separates light fluxes of the reflected light of the first and second laser light from each other, the light fluxes being obtained by dividing the reflected light of the first and second laser light into four light fluxes by two straight lines respectively in parallel to the first and second directions; and a photodetector which receives the separated light fluxes of the reflected light of the first and second laser light to output a detection signal. In this arrangement, the light separating portion is constituted of at least one prism having a plurality of slopes, and the photodetector is provided with a common sensor portion which receives the light fluxes of the reflected light of the first laser light, and the light fluxes of the reflected light of the second laser light.

### BRIEF DESCRIPTION OF THE DRAWINGS

These and other objects, and novel features of the present invention will become more apparent upon reading the following detailed description of the embodiment along with the accompanying drawings.

FIGS. 1A and 1B are diagrams for describing a technical principle (as to how light rays converge) in an embodiment of the invention.

FIGS. 2A through 2D are diagrams for describing the technical principle (as to how light fluxes are distributed) in the embodiment.

FIGS. 3A through 3D are diagrams for describing the technical principle (as to how signal light and stray light are distributed) in the embodiment.

FIGS. 4A and 4B are diagrams for describing the technical principle (a method for separating light fluxes) in the embodiment.

FIGS. 5A through 5D are diagrams for describing a method for arranging sensors in the embodiment.

FIG. 6 is a diagram showing a preferable range to which the technical principle of the embodiment is applied.

FIGS. 7A and 7B are diagrams showing an optical system of an optical pickup device as an inventive example, and FIG. 7C is a diagram showing how a light flux entered into an anamorphic lens converges.

FIG. 8A is a perspective view showing an arrangement of a light separating element in the inventive example, and FIG. 8B is a diagram schematically showing how the propagating direction of laser light is changed by the light separating element.

FIG. 9 is a diagram showing a sensor layout of a photodetector in the inventive example.

FIGS. 10A through 10C are diagrams showing an optical system of an optical pickup device as modification example 1, and diffraction efficiency of laser light.

FIG. 11A is a diagram showing an optical system of an optical pickup device as modification example 2, and FIGS. 11B and 11C are perspective views showing an arrangement of a complex lens.

FIGS. 12A and 12B are diagrams showing an optical system of an optical pickup device as modification example 3.

FIGS. 13A and 13B are diagrams showing an optical system of an optical pickup device as modification example 4.

FIGS. 14A and 14B are perspective views respectively showing arrangements of a half mirror and an astigmatism plate in modification example 4, and FIGS. 14C through 14E are diagrams schematically showing how the propagating direction of laser light is changed by the half mirror and the astigmatism plate.

FIGS. 15A and 15B are perspective views respectively showing arrangements of a half mirror and an astigmatism plate in modification example 4, and FIGS. 15C through 15E are diagrams schematically showing how the propagating direction of laser light is changed by the half mirror and the astigmatism plate.

FIGS. 16A and 16B are diagrams showing an optical system of an optical pickup device as another modification example.

The drawings are provided mainly for describing the present invention, and do not limit the scope of the present invention.

### DESCRIPTION OF PREFERRED EMBODIMENTS

In the following, an embodiment of the invention is described referring to the drawings.

### <Technical Principle>

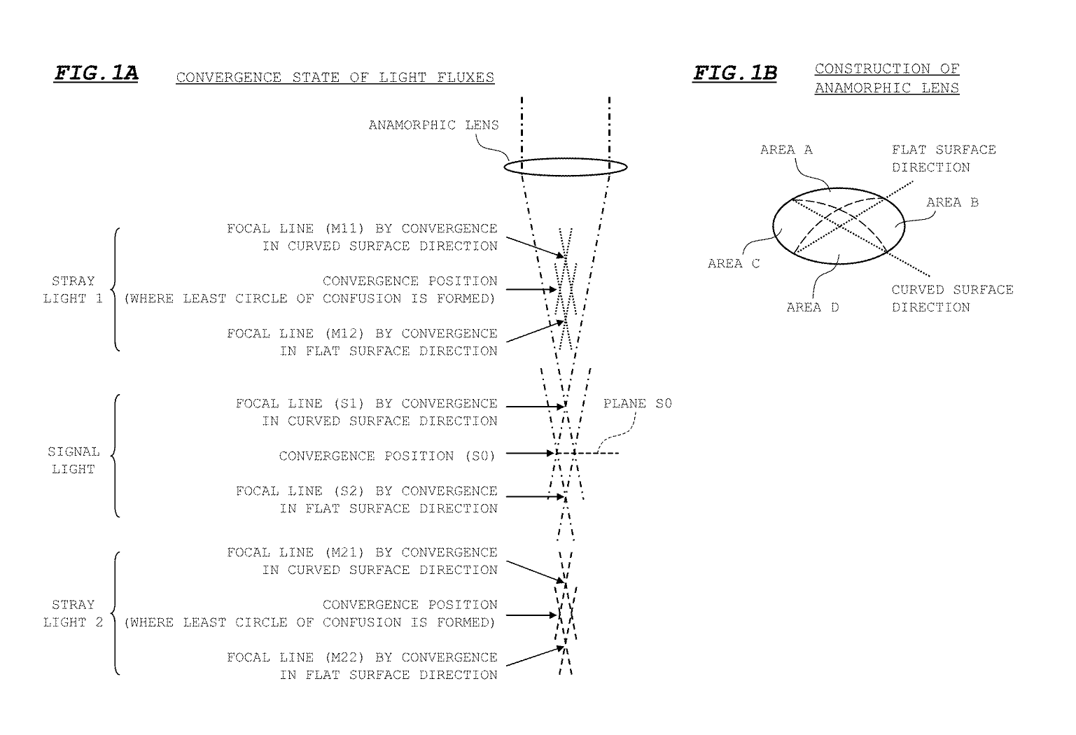

First, a technical principle to which the embodiment of the invention is applied is described referring to FIGS. 1A through 6.

FIG. 1A and 1B are diagrams showing a state as to how light rays are converged. FIG. 1A is a diagram showing a state as to how laser light (signal light) reflected on a target recording layer, laser light (stray light 1) reflected on a layer located at a rearward position with respect to the target recording layer, and laser light (stray light 2) reflected on a layer located at a forward position with respect to the target recording layer are converged. FIG. 1B is a diagram showing an arrangement of an anamorphic lens to be used in the technical principle.

Referring to FIG. 1B, the anamorphic lens has a function of converging laser light to be entered in a direction in parallel to the lens optical axis, in a curved surface direction and a flat surface direction. The curved surface direction and the flat surface direction intersect perpendicularly to each other. Further, the curved surface direction has a smaller radius of curvature than that of the flat surface direction, and has a greater effect of converging laser light to be entered into the anamorphic lens.

To simplify the description on the astigmatism function of the anamorphic lens, the terms “curved surface direction” and “flat surface direction” are used. Actually, however, as far as the anamorphic lens has a function of forming focal lines at different positions from each other, the shape of the anamorphic lens in the “flat surface direction” in FIG. 1B is not limited to a flat plane shape. In the case where laser light is entered into the anamorphic lens in a convergence state, the shape of the anamorphic lens in the “flat surface direction” maybe a straight line shape (where the radius of curvature=∞).

Referring to FIG. 1A, signal light converged by the anamorphic lens forms focal lines at different positions from each other by convergence in the curved surface direction and in the flat surface direction. The focal line position (S1) of signal light by convergence in the curved surface direction is close to the anamorphic lens than the focal line position (S2) of signal light by convergence in the flat surface direction, and the convergence position (S0) of signal light is an intermediate position between the focal line positions (S1) and (S2) by convergence in the curved surface direction and in the flat surface direction.

Similarly to the above, the focal line position (M11) of stray light 1 converged by the anamorphic lens by convergence in the curved surface direction is close to the anamorphic lens than the focal line position (M12) of stray light 1 by convergence in the flat surface direction. The anamorphic lens is designed to make the focal line position (M12) of stray light 1 by convergence in the flat surface direction close to the anamorphic lens than the focal line position (S1) of signal light by convergence in the curved surface direction.

Similarly to the above, the focal line position (M21) of stray light 2 converged by the anamorphic lens in the curved surface direction is close to the anamorphic lens than the focal line position (M22) of stray light 2 by convergence in the flat surface direction. The anamorphic lens is designed to make the focal line position (M21) of stray light 2 by convergence in the curved surface direction away from the anamorphic lens than the focal line position (S2) of signal light by convergence in the flat surface direction.

Further, the beam spot of signal light has a shape of a least circle of confusion on the convergence position (S0) between the focal line position (S1) and the focal line position (S2).

Taking into account the above matters, the following is a description about a relationship between irradiation areas of signal light and stray light 1, 2 on the plane SO.

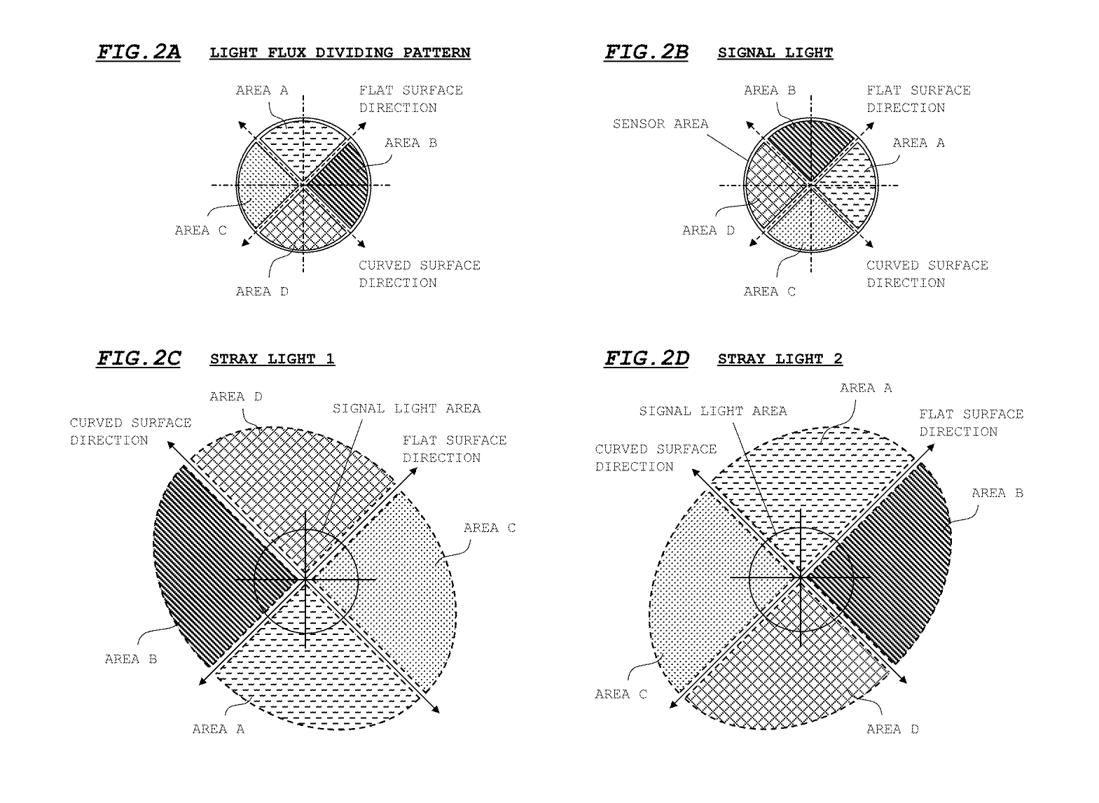

As shown in FIG. 2A, the anamorphic lens is divided into four areas A through D. In this case, signal light entered into the areas A through D is distributed on the plane SO, as shown in FIG. 2B. Further, stray light 1 entered into the areas A through D is distributed on the plane SO, as shown in FIG. 2C, and stray light 2 entered into the areas A through D is distributed on the plane SO, as shown in FIG. 2D.

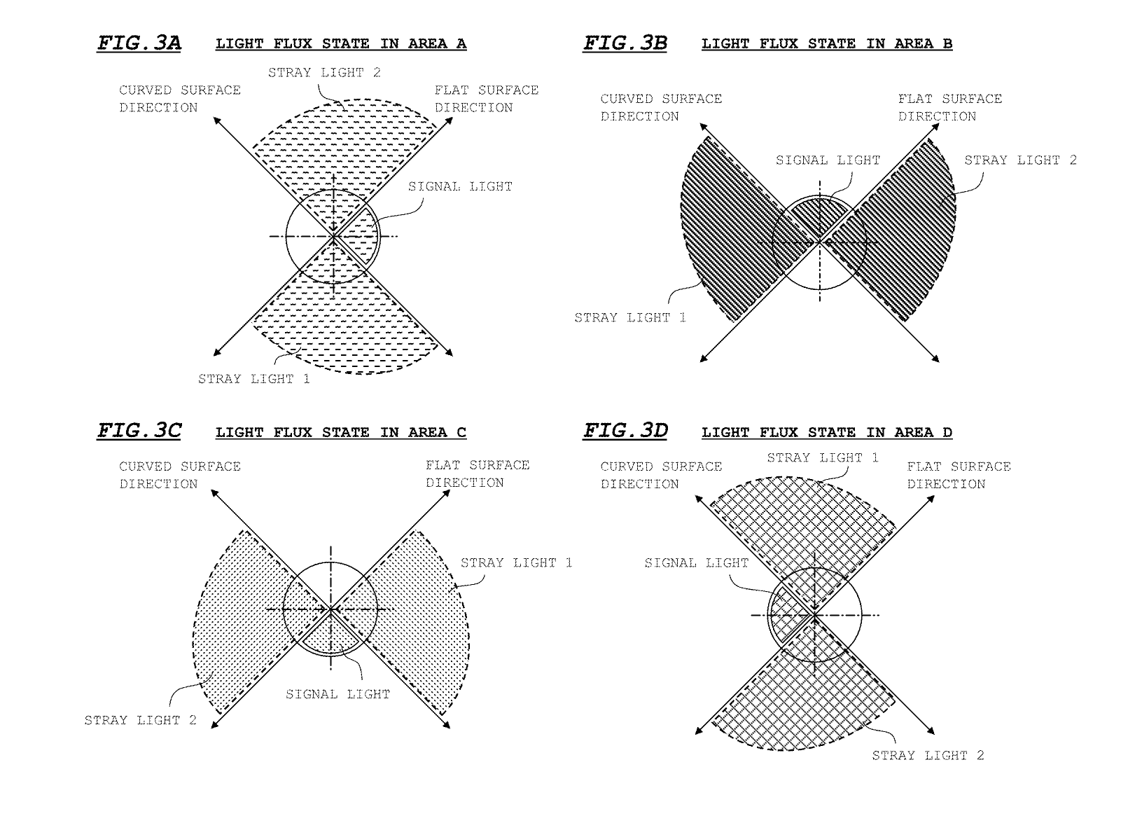

If signal light and stray light 1, 2 on the plane SO are extracted in each of light flux areas, the distributions of the respective light are as shown in FIGS. 3A through 3D. In this case, stray light 1 and stray light 2 in the same light flux area are not overlapped with signal light in each of the light flux areas. Accordingly, if the device is configured such that only signal light is received by a sensor after light fluxes (signal light, stray light 1, 2) in each of the light flux areas are separated in different directions, only signal light is entered into a corresponding sensor to thereby suppress incidence of stray light. Thus, it is possible to avoid degradation of a detection signal resulting from stray light.

As described above, it is possible to extract only signal light by dispersing and separating light passing through the areas A through D from each other on the plane SO. The embodiment is made based on the above technical principle.

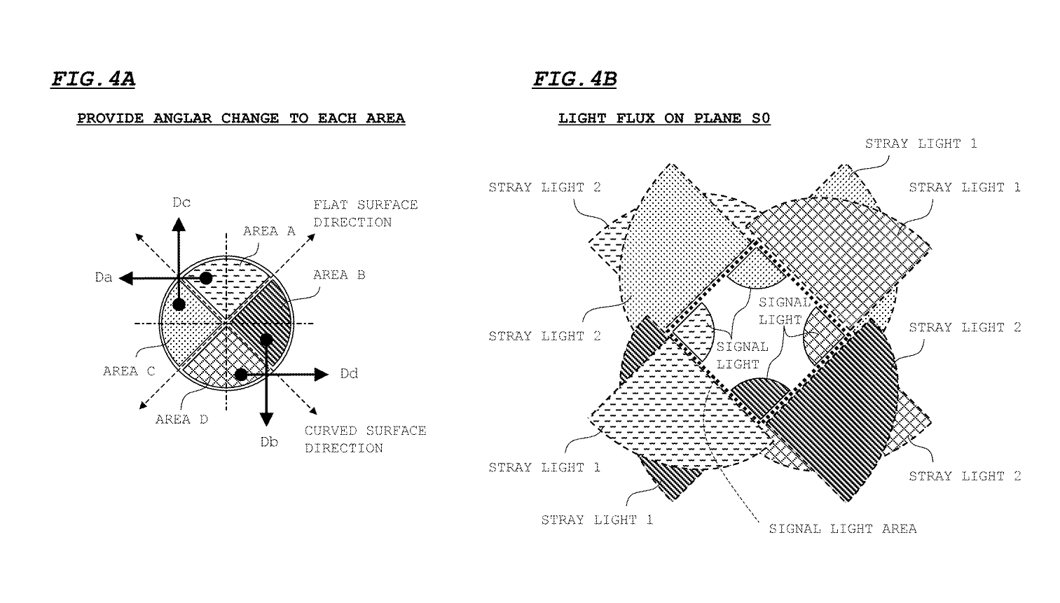

FIGS. 4A and 4B are diagrams showing a distribution state of signal light and stray light 1, 2 on the plane S0, in the case where the propagating directions of light fluxes (signal light, stray light 1, 2) passing through the four areas A through D shown in FIG. 2A are respectively changed in different directions by the same angle. FIG. 4A is a diagram of the anamorphic lens when viewed from the optical axis direction of the anamorphic lens (the propagating direction along which laser light is entered into the anamorphic lens), and FIG. 4B is a diagram showing a distribution state of signal light, stray light 1, 2 on the plane S0.

In FIG. 4A, the propagating directions of light fluxes (signal light, stray light 1, 2) that have passed through the areas A through D are respectively changed into directions Da, Db, Dc, Dd by the same angle amount α (not shown) with respect to the propagating directions of the respective light fluxes before incidence. The directions Da, Db, Dc, Dd each has an inclination of 45° with respect to the flat surface direction and the curved surface direction.

In this case, as shown in FIG. 4B, it is possible to distribute signal light and stray light 1, 2 in each of the light flux areas, on the plane S0, by adjusting the angle amount α with respect to the directions Da, Db, Dc, Dd. As a result of the above operation, as shown in FIG. 4B, it is possible to form a signal light area where only signal light exists on the plane S0. By disposing sensors of a photodetector in the signal light area, it is possible to receive only signal light in each of the light flux areas by a corresponding sensor.

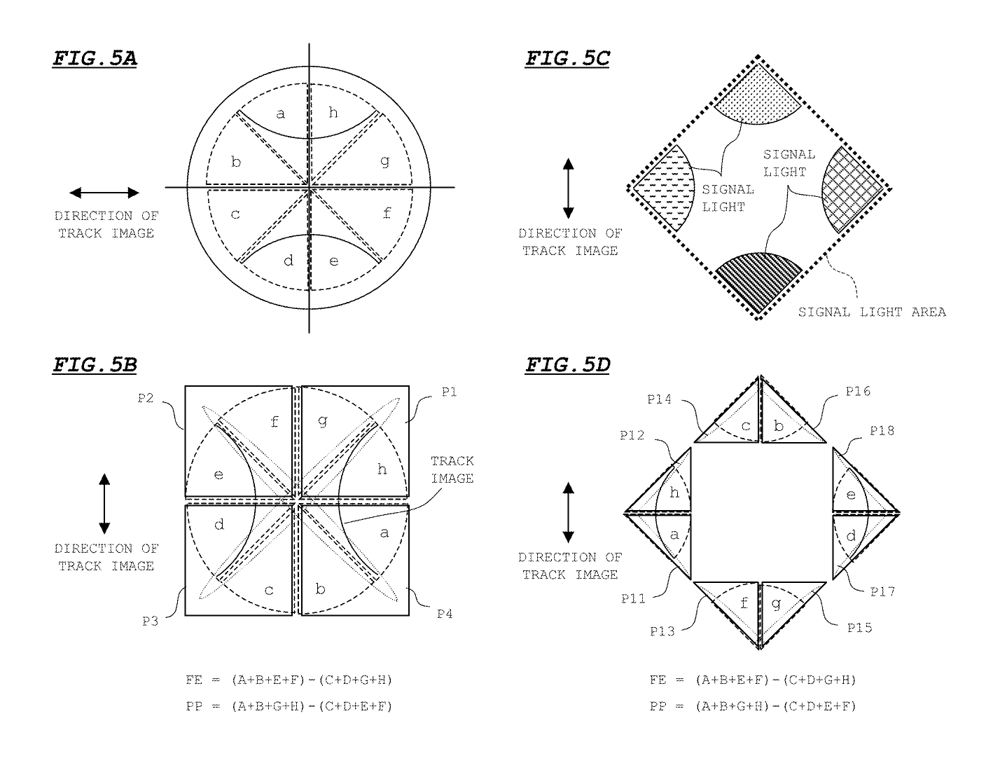

FIGS. 5A through 5D are diagrams showing a method for arranging sensors. FIG. 5A is a diagram showing light flux areas of reflected light (signal light) on a disc, and FIG. 5B is a diagram showing a distribution state of signal light on a photodetector, in the case where an anamorphic lens and a photodetector (a four-divided sensor) based on a conventional astigmatism method are respectively disposed on the arranged position of the anamorphic lens and on the plane S0, in the arrangement shown in FIG. 1A. FIGS. 5C and 5D are diagrams showing a distribution state of signal light and a sensor layout based on the above principle, on the plane S0.

The direction of a diffraction image (a track image) of signal light resulting from a track groove has an inclination of 45° with respect to the flat surface direction and the curved surface direction. In FIG. 5A, assuming that the direction of a track image is aligned with leftward and rightward directions, in FIGS. 5B through 5D, the direction of a track image by signal light is aligned in upward and downward directions. In FIGS. 5A, 5B and 5D, to simplify the description, a light flux is divided into eight light flux areas a through h. Further, the track image is shown by the solid line, and the beam shape in an out-of-focus state is shown by the dotted line.

It is known that an overlapped state of a zero-th order diffraction image and a first-order diffraction image of signal light resulting from a track groove is obtained by an equation: wavelength/(track pitch×objective lens NA). As shown in FIGS. 5A, 5B, 5D, a requirement that a first-order diffraction image is formed in the four light flux areas a, b, e, h is expressed by: wavelength track pitch×objective lens NA>√2.

In the conventional astigmatism method, sensors P1 through P4 (a four-divided sensor) of a photodetector are arranged as shown in FIG. 5B. In this case, assuming that detection signal components based on light intensities in the light flux areas a through h are expressed by A through H, a focus error signal FE and a push-pull signal PP are obtained by the following equations (1) and (2).

FE=(A+B+E+F)−(C+D+G+H) (1)

PP=(A+B+G+H)−(C+D+E+F) (2)

On the other hand, as described above, signal light is distributed in the signal light area as shown in FIG. 5C in the distribution state shown in FIG. 4B. In this case, signal light passing through the light flux areas a through h shown in FIG. 5A is distributed as shown in FIG. 5D. Specifically, signal light passing through the light flux areas a through h in FIG. 5A are guided to the light flux areas a through h shown in FIG. 5D, on the plane S0 where the sensors of the photodetector are disposed.

Accordingly, by disposing the sensors P11 through P18 at the positions of the light flux areas a through h shown in FIG. 5D in an overlapped state as shown in FIG. 5D, it is possible to generate a focus error signal and a push-pull signal by performing the same computation as applied to the process described in the case of FIG. 5B. Specifically, assuming that A through H represent detection signals from the sensors for receiving light fluxes in the light flux areas a through h, a focus error signal FE and a push-pull signal PP can be acquired by the above equations (1) and (2) in the same manner as described in the case of FIG. 5B.

As described above, according to the above principle, it is possible to generate a focus error signal and a push-pull signal (a tracking error signal) with no or less influence of stray light by performing the same computation as applied to the process based on the conventional astigmatism method.

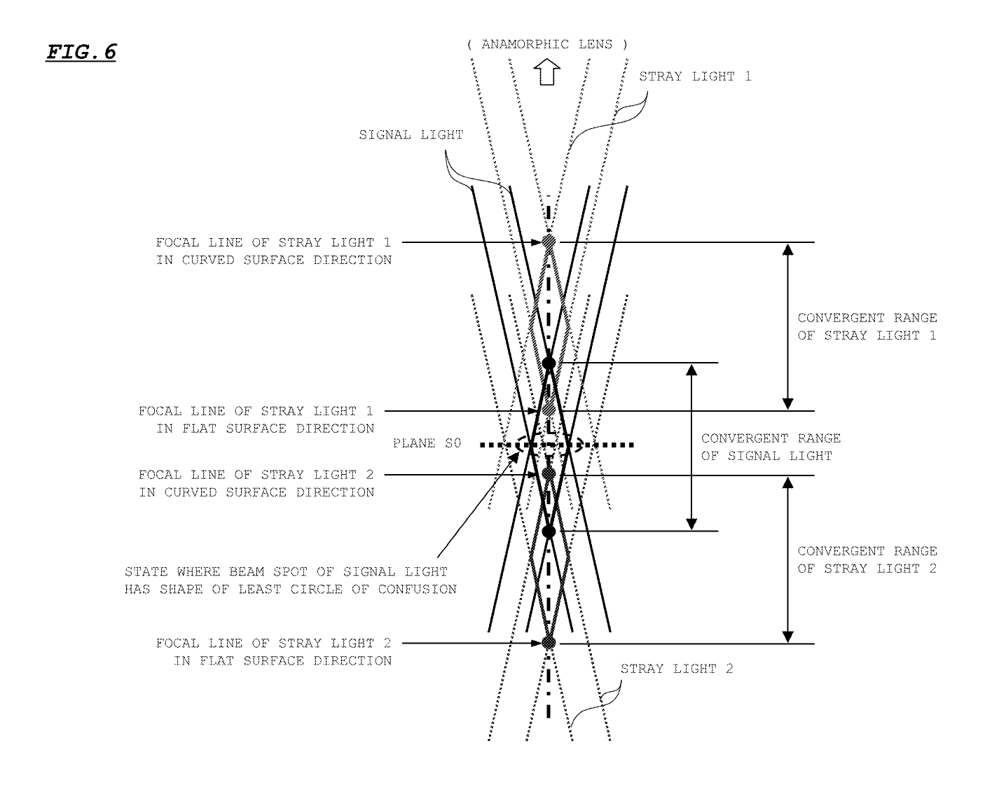

The effect by the above principle is obtained, as shown in FIG. 6, in the case where the focal line position of stray light 1 in the flat surface direction is close to the anamorphic lens with respect to the plane S0 (a plane where the beam spot of signal light has a shape of a least circle of confusion), and the focal line position of stray light 2 in the curved surface direction is away from the anamorphic lens with respect to the plane S0. Specifically, as far as the above relationship is satisfied, the distribution state of signal light, and stray light 1, 2 is as shown in FIG. 4B, which makes it possible to keep signal light, and stray light 1, 2 from overlapping each other on the plane S0. In other words, as far as the above relationship is satisfied, the advantage based on the above principle is obtained, even if the focal line position of stray light 1 in the flat surface direction comes closer to the plane S0 than the focal line position of signal light in the curved surface direction, or even if the focal line position of stray light 2 in the curved surface direction comes closer to the plane S0 than the focal line position of signal light in the flat surface direction.

### EXAMPLE

The present example is an example, wherein the invention is applied to an optical pickup device compatible with BD, DVD and CD.

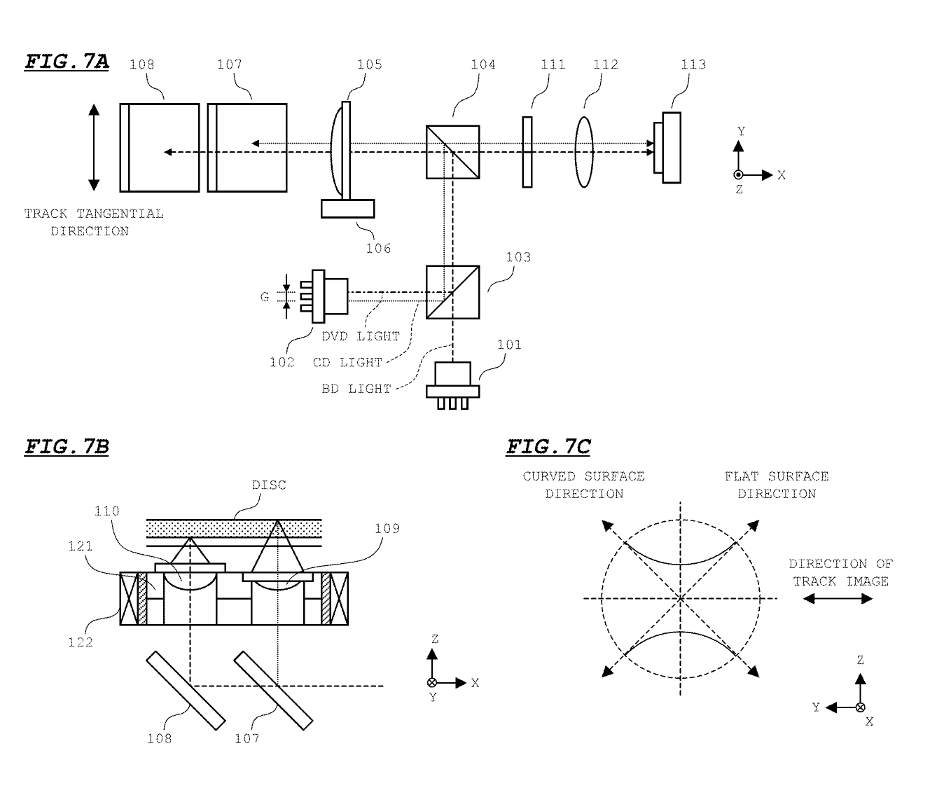

FIGS. 7A, 7B are diagrams showing an optical system of an optical pickup device as an inventive example. FIG. 7A is a plan view of the optical system, wherein elements on the disc side with respect to rise-up mirrors 107, 108 are omitted, and FIG. 7B is a perspective side view of the optical system on the disc side, when viewed from the rise-up mirrors 107, 108.

As shown in FIGS. 7A, 7B, the optical pickup device is provided with a semiconductor laser 101, a dual wavelength laser 102, a dichroic mirror 103, a Polarized Beam Splitter (PBS) 104, a collimator lens 105, a lens actuator 106, the rise-up mirrors 107, 108 a dual wavelength objective lens 109, a BD objective lens 110, a light separating element 111, an anamorphic lens 112, and a photodetector 113.

The semiconductor laser 101 emits laser light (hereinafter, called as “BD light”) for BD and having a wavelength of or about 405 nm. The dual wavelength laser 102 accommodates, in a certain CAN, two laser elements which respectively emit laser light (hereinafter, called as “DVD light”) for DVD and having a wavelength of or about 660 nm, and laser light (hereinafter, called as “CD light”) for CD and having a wavelength of or about 785 nm. The emission points of DVD light and CD light are aligned in Y-axis direction, and the gap between the emission points is represented by G.

As will be described later, the gap G between the emission points of CD light and DVD light is set to such a value that CD light is properly irradiated onto a sensor portion for CD light. Accommodating two light sources in one CAN as described above is advantageous in simplifying the optical system, as compared with an arrangement provided with plural CANs.

The dichroic mirror 103 transmits BD light, and reflects CD light and DVD light. The semiconductor laser 101 and the dual wavelength laser 102 are disposed at such positions that the optical axis of BD light transmitted through the dichroic mirror 103, and the optical axis of DVD light reflected on the dichroic mirror 103 are aligned with each other. The optical axis of CD light reflected on the dichroic mirror 103 is displaced from the optical axes of BD light and DVD light by the gap G.

The PBS 104 reflects BD light, DVD light, CD light to be entered from the side of the dichroic mirror 103, and allows the reflected light to be entered into the collimator lens 105. In this way, the polarization directions of laser light to be emitted from the semiconductor laser 101 and the dual wavelength laser 102 are set in such a manner that BD light, DVD light, CD light are reflected on the PBS 104.

The collimator lens 105 converts BD light, DVD light, CD light to be entered from the side of the PBS 104 into parallel light. The lens actuator 106 moves the collimator lens 105 in the optical axis direction in accordance with a control signal for aberration correction.

The rise-up mirror 107 is a dichroic mirror. The rise-up mirror 107 transmits BD light, and reflects DVD light and CD light in a direction toward the dual wavelength objective lens 109. The rise-up mirror 108 reflects BD light in a direction toward the BD objective lens 110.

The dual wavelength objective lens 109 is so configured as to properly focus DVD light and CD light on DVD and CD respectively. Further, the BD objective lens 110 is so configured as to properly focus BD light on BD. The dual wavelength objective lens 109 and the BD objective lens 110 are driven in a focus direction and in a tracking direction by an objective lens actuator 122, while being held on a holder 121. The track tangential direction on the disc is aligned with Y-axis direction.

BD light reflected on BD passes through the BD objective lens 110 and the rise-up mirrors 108, 107 again, and then is entered into the collimator lens 105. Likewise, DVD light and CD light reflected on DVD and CD pass through the dual wavelength objective lens 109 and the rise-up mirror 107 again, and then are entered into the collimator lens 105. The collimator lens 105 converts BD light, DVD light, CD light to be entered from the side of the rise-up mirror 107 to the collimator lens 105 into convergent light. BD light, DVD light, CD light, which have been converted into convergent light by the collimator lens 105, are substantially totally transmitted through the PBS 104, and then are entered into the light separating element 111.

The light separating element 111 is constituted of a multifaceted prism. BD light, DVD light, CD light entered into the light separating element 111 are each separated into four light fluxes, and the propagating direction of each of the light fluxes is changed by refraction of the light separating element 111.

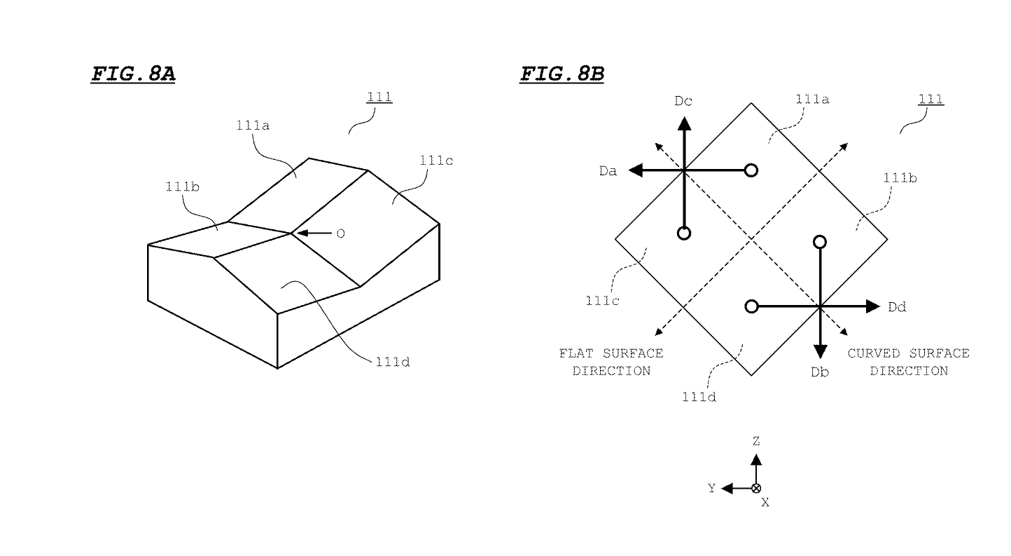

FIG. 8A is a perspective view showing an arrangement of the light separating element 111. FIG. 8B is a diagram schematically showing how the propagating direction of BD light, DVD light, CD light is changed by the light separating element 111. FIG. 8B is a plan view of the light separating element 111, when viewed from the side of the PBS 104. FIG. 8B also shows the flat surface direction and the curved surface direction of the anamorphic lens 112.

As shown in FIG. 8A, the light separating element 111 is formed with four slopes 111a through 111d on the output surface thereof. The four slopes 111a through 111d are so configured that the propagating directions of light fluxes to be entered into the respective slopes are adjusted to propagate in the directions of arrows Da through Dd shown in FIG. 8B. The directions Da through Dd shown in FIG. 8B correspond to the arrows Da through Dd shown in FIG. 4A.

The light separating element 111 is disposed at such a position that the optical axes of BD light and DVD light to be entered from the side of the PBS 104 pass through the point (a center point O) at which the slopes 111a through 111d intersect each other on the output surface. In this arrangement, as shown in FIG. 7A, since the optical axis of CD light, and the optical axes of the BD light and DVD light are displaced from each other, the optical axis of CD light to be entered from the side of the PBS 104 is displaced from the center point O on the output surface of the light separating element 111. Since the light separating element 111 is constituted of a multifaceted prism, the refraction angles of BD light, DVD light, CD light by the light separating element 111 are substantially set to the same angle.

Referring back to FIG. 7A, the anamorphic lens 112 imparts astigmatism to BD light, DVD light, CD light entered from the side of the light separating element 111. The anamorphic lens 112 corresponds to the anamorphic lens shown in FIGS. 1A, 1B.

FIG. 7C is a diagram of light fluxes to be entered into the anamorphic lens 112, when viewed from the propagating direction (plus X-axis direction) of light fluxes, in the absence of the light separating element 111. As shown in FIG. 7C, the direction of a track image of a light flux to be entered into the anamorphic lens is aligned with Y-axis direction.

As shown in FIG. 7C, the light flux to be entered into the anamorphic lens 112 undergoes convergence in the flat surface direction and in the curved surface direction. Accordingly, if the light separating element 111 shown in FIGS. 8A, 8B is disposed at a position anterior to the anamorphic lens 112 configured as described above, laser light reflected on the disc is irradiated onto the light receiving surface of the photodetector 113, as shown in FIG. 4B, by the functions of the light separating element 111 and the anamorphic lens 112.

Referring back to FIG. 7A, BD light, DVD light, CD light transmitted through the anamorphic lens 112 are entered into the photodetector 113. The photodetector 113 has a sensor layout for receiving BD light, DVD light, CD light.

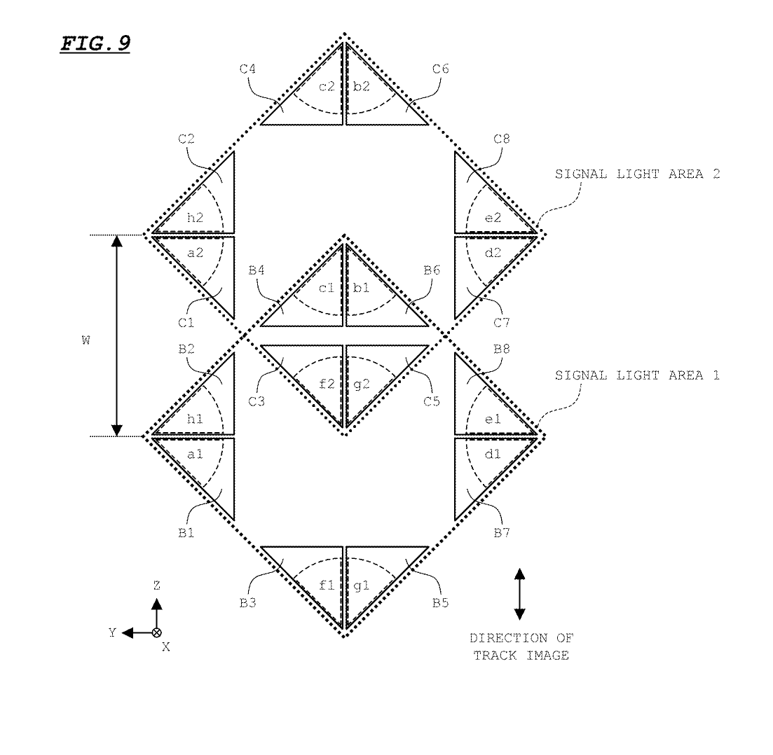

FIG. 9 is a diagram showing a sensor layout of the photodetector 113.

The photodetector 113 has sensors B1 through B8 for receiving BD light and DVD light, and sensors C1 through C8 for receiving CD light. The sensor layout constituted of the sensors B1 through B8, and the sensor layout constituted of the sensors C1 through C8 have substantially the same configuration as each other, and are disposed away from each other by an interval W in the direction of a track image.

For sake of simplicity, assuming that signal light of BD light and signal light of DVD light are respectively divided into light flux areas a through h as shown in FIG. 5A, the light flux areas a through h of signal light of BD light and the light flux areas a through h of signal light of DVD light are separated in the same manner as described based on the aforementioned technical principle, and light on the light flux areas a through h of signal light of BD light and light on the light flux areas a through h of signal light of DVD light are irradiated onto irradiation areas al through h1 shown in FIG. 9, on the photodetector 113. At the time of the irradiation, the irradiation areas al through h1 of BD light and DVD light are positioned near four vertices within a signal light area 1. The sensors B1 through B8 are disposed near the four vertices of the signal light area 1, and accordingly, the sensors B1 through B8 respectively detect signal light of BD light and signal light of DVD light to be irradiated onto the irradiation areas a1, h1, f1, c1, g1, b1, d1, e1.

Likewise, for sake of simplicity, assuming that signal light of CD light is divided into light flux areas a through h as shown in FIG. 5A, the light flux areas a through h of signal light of CD light are separated in the same manner as described based on the aforementioned technical principle, and light on the light flux areas a through h of signal light of CD light is irradiated onto irradiation areas a2 through h2 shown in FIG. 9, on the photodetector 113. At the time of the irradiation, the irradiation areas a2 through h2 of CD light are positioned near four vertices within a signal light area 2. The sensors C1 through C8 are disposed near the four vertices of the signal light area 2, and accordingly, the sensors C1 through C8 respectively detect signal light of CD light to be irradiated onto the irradiation areas a2, h2, f2, c2, g2, b2, d2, e2.

The interval W between the sensor layout constituted of the sensors B1 through B8, and the sensor layout constituted of the sensors C1 through C8 is set depending on the gap G between the emission points of DVD light and CD light to be emitted from the dual wavelength laser 102, and the curvature of the anamorphic lens 112.

As described above, in the inventive example, signal light of BD light and signal light of DVD light are received by the common sensors B1 through B8. With this arrangement, there is no need of disposing a sensor portion corresponding to BD light and a sensor portion corresponding to DVD light individually, on the light receiving surface of the photodetector 113. Thus, it is possible to make the area of the light receiving surface of the photodetector 113 small. This is advantageous in miniaturizing the optical pickup device.

Further, in the inventive example, since the light separating element 111 is constituted of a multifaceted prism, it is possible to form the light separating element 111 of a plastic material. Thus, the light separating element 111 can be manufactured at a lower cost. This is advantageous in reducing the cost required for the optical pickup device.

As shown in the inventive example, concerning DVD light and CD light to be emitted from the dual wavelength laser 102, it is desirable to align the optical axis of DVD light with the optical axis of BD light, in place of aligning the optical axis of CD light with the optical axis of BD light. This is because of the following reason.

In the case where DVD light is irradiated onto DVD-RAM, the track width is large and the ball pattern resulting from a track groove is large, as compared with the case where DVD light is irradiated onto DVD other than DVD-RAM. As a result, if the optical axis of CD light is aligned with the optical axis of BD light, in place of aligning the optical axis of DVD light with the optical axis of BD light, the optical axis of DVD light maybe displaced from the center of the light separating element 111 and the anamorphic lens 112. This makes it difficult to obtain a proper detection signal in use of DVD-RAM. In view of the above, in the inventive example, the optical axis of DVD light is aligned with the optical axis of BD light.

### Modification Example 1

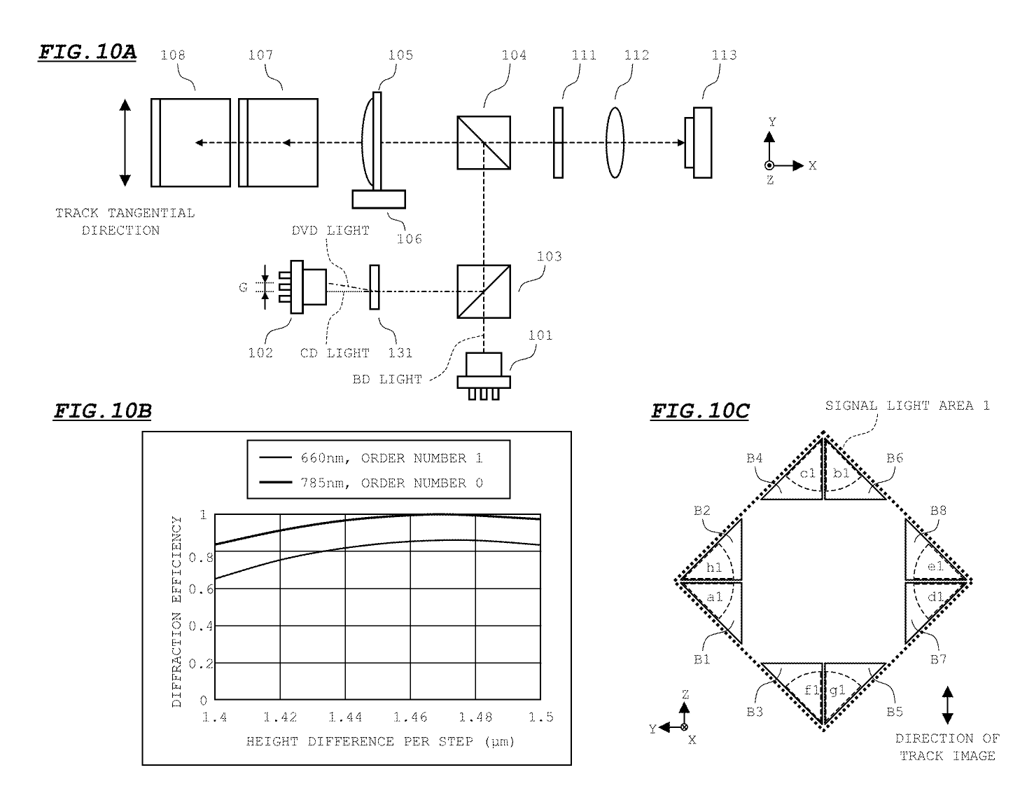

FIG. 10A is a diagram showing a part of an optical system of an optical pickup device in this modification example. The optical system of the optical pickup device in this modification example is configured by additionally disposing a diffraction element 131 between the dual wavelength laser 102 and the dichroic mirror 103, in the optical system of the optical pickup device shown in FIGS. 7A, 7B. The illustration on the elements of the optical system of the optical pickup device in this modification example, on the disc side with respect to the rise-up mirrors 107, 108, is omitted herein to simplify the description.

As shown in FIG. 10A, in this modification example, the optical axis of DVD light is aligned with the optical axis of CD light by the diffraction element 131. The diffraction element 131 has a diffraction pattern on a surface thereof on the side of the dichroic mirror 103. The diffraction pattern is adapted to diffract only DVD light by a predetermined angle. With this arrangement, the optical axes of DVD light and CD light are aligned with each other on the output surface of the diffraction element 131. The optical axes of DVD light and CD light which has been aligned with each other as described above are also aligned with the optical axis of BD light by the dichroic mirror 103. In this way, the optical axes of BD light, DVD light, CD light directed from the dichroic mirror 103 toward the PBS 104 are aligned with each other.

In this example, the diffraction pattern of the diffraction element 131 has e.g. a five-step structure, and the height difference per step is set to 1.46 nm. With this arrangement, as shown in FIG. 10B, CD light is substantially totally transmitted through the diffraction element 131, and the diffraction efficiency of first order diffraction light of DVD light is about 86%. Thus, it is possible to suppress power loss of DVD light.

Configuring the optical system of the optical pickup device as described above provides substantially the same effect as in the inventive example. Further, in this modification example, since the optical axes of BD light, DVD light, CD light are aligned with each other, it is possible to form the sensor layouts on the photodetector 113 as one sensor layout. Specifically, it is possible to receive all the signal light of BD light, DVD light, CD light on the sensors B1 through B8 shown in FIG. 9. FIG. 10C is a diagram showing a sensor layout in this modification example. With the formation of a sensor layout in this modification example, it is possible to make the surface area of the photodetector 113 small, as compared with the inventive example. This is advantageous in miniaturizing the optical pickup device.

### Modification Example 2

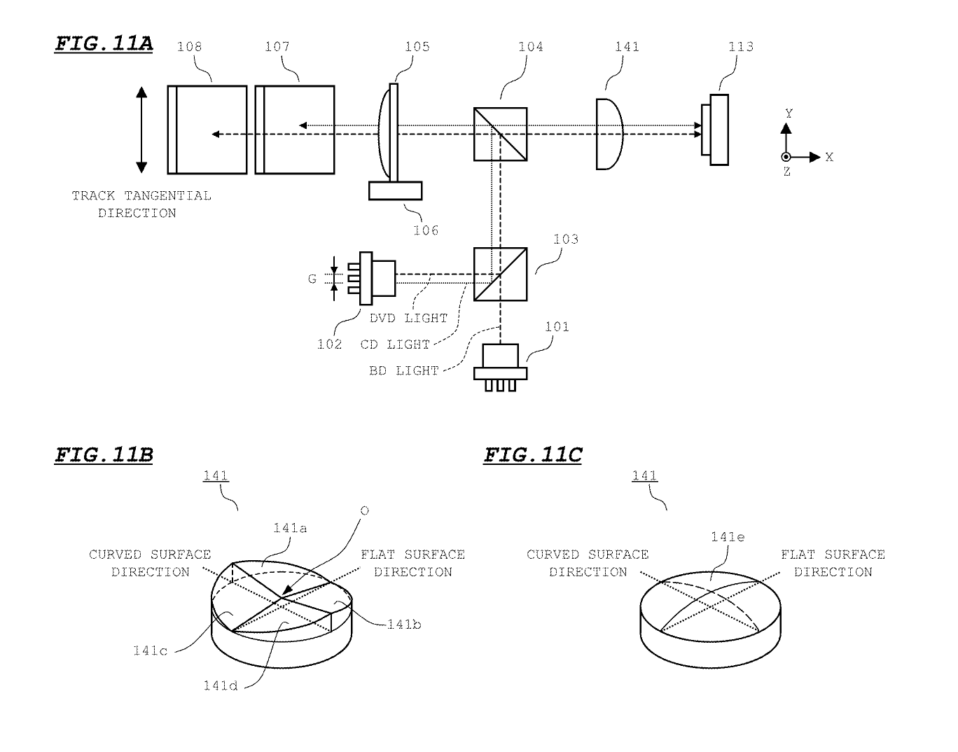

FIG. 11A is a diagram showing a part of an optical system of an optical pickup device in this modification example. The optical system of the optical pickup device in this modification example is configured by removing the light separating element 111 and the anamorphic lens 112 from the optical system of the optical pickup device shown in FIGS. 7A, 7B, and by disposing a complex lens 141 between the PBS 104 and the photodetector 113. The illustration on the elements of the optical system of the optical pickup device in this modification example, on the disc side with respect to the rise-up mirrors 107, 108, is omitted herein to simplify the description.

FIGS. 11B, 11C are perspective views showing an arrangement of the complex lens 141. FIG. 11A is a perspective view of the complex lens 141 when viewed from the side of the PBS 104, and FIG. 11B is a perspective view of the complex lens 141 when viewed from the side of the photodetector 113.

As shown in FIG. 11B, slopes 141a through 141d are formed on a surface of the complex lens 141 on the side of the PBS 104 in the same manner as the slopes 111a through 111d of the light separating element 111 in the inventive example. Further, the complex lens 141 is disposed at such a position that the optical axes of BD light and DVD light reflected on the disc pass through the point (a center point O) at which the slopes 141a through 141d intersect each other in the same manner as the inventive example.

As shown in FIG. 11C, a toric surface 141e for imparting astigmatism to BD light, DVD light, and CD light in the same manner as the anamorphic lens 112 in the inventive example is formed on a surface of the complex lens 141 on the side of the photodetector 113.

Configuring the optical system of the optical pickup device as described above provides substantially the same effect as in the inventive example. Further, in this modification example, since the complex lens 141 is used in place of the light separating element 111 and the anamorphic lens 112, the number of parts constituting the optical pickup device is reduced, as compared with the inventive example. This is advantageous in miniaturizing the optical pickup device, as compared with the inventive example.

### Modification Example 3

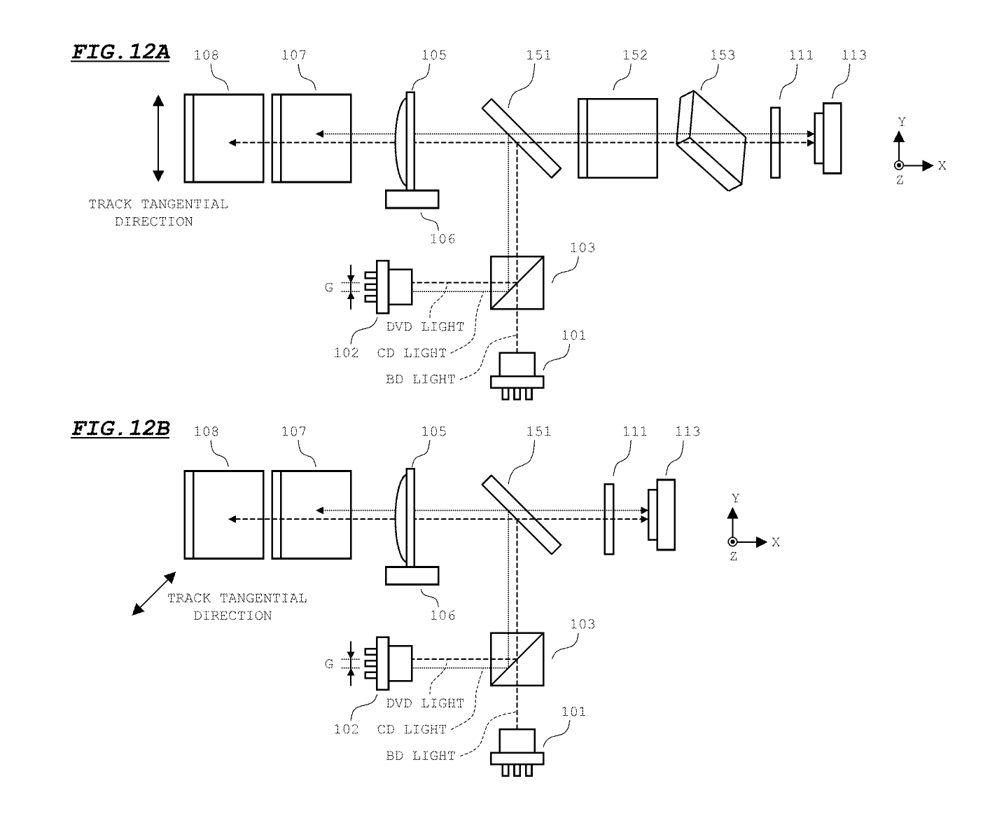

FIG. 12A is a diagram showing a part of an optical system of an optical pickup device in this modification example. The optical system of the optical pickup device in this modification example is configured by disposing a half mirror 151 and astigmatism plates 152, 153 in the optical system of the optical pickup device shown in FIGS. 7A, 7B, in place of the PBS 104 and the anamorphic lens 112. The illustration on the elements of the optical system of the optical pickup device in this modification example, on the disc side with respect to the rise-up mirrors 107, 108, is omitted herein to simplify the description.

The half mirror 151 reflects and transmits entered laser light on an incident surface thereof with a ratio of 50:50 (%). With this arrangement, the half mirror 151 reflects laser light to be entered from the side of the dichroic mirror 103 toward the collimator lens 105, and transmits laser light to be entered from the side of the collimator lens 105 in plus X-axis direction. The half mirror 151 is a flat parallel plate. The incident surface of the half mirror 151 is inclined about Z-axis by 45 degrees from a state in parallel to Y-Z plane. Further, laser light to be entered into the half mirror 151 from the side of the collimator lens 105 is convergent light. Accordingly, laser light to be entered into the half mirror 151 is converged in Y-axis direction by transmission through the half mirror 151.

The astigmatism plate 152 is a transparent flat parallel plate. The incident surface of the astigmatism plate 152 is inclined about Y-axis by 45 degrees from a state in parallel to Y-Z plane. Further, laser light to be entered into the astigmatism plate 152 from the side of the half mirror 151 is convergent light. Accordingly, laser light to be entered into the astigmatism plate 152 is converged in Z-axis direction by transmission through the astigmatism plate 152.

The thickness, the refractive index, and the inclination angle of the astigmatism plate 152 are adjusted to such values that the astigmatism by the half mirror 151 and the astigmatism by the astigmatism plate 152 are substantially cancelled out each other. Accordingly, only the effect of astigmatism by the astigmatism plate 153 remains.

The astigmatism plate 153 is a transparent flat parallel plate. The incident surface of the astigmatism plate 153 is inclined by 45 degrees with respect to the direction of a track image of reflected light. Specifically, the incident surface of the astigmatism plate 153 is inclined about Y-axis from a state in parallel to Y-Z plane, and is further inclined about the optical axes of BD light and DVD light by 45 degrees. With this arrangement, laser light to be entered into the astigmatism plate 153 is converged in a direction displaced from the direction of a track image by 45 degrees, when viewed from X-axis direction, by transmission through the astigmatism plate 153. Thus, astigmatism is imparted to laser light.

The inclination direction of the astigmatism plate 153 is aligned with such a direction that coma aberrations generated by the half mirror 151 and the astigmatism plate 152 are concurrently suppressed by coma aberration generated by the astigmatism plate 153. The thickness, the refractive index, and the inclination angle of the astigmatism plate 153 are adjusted to such values that coma aberrations generated by the half mirror 151 and the astigmatism plate 152 can be suppressed, and that an intended astigmatism can be obtained.

As described above, when laser light is converged by each of the half mirror 151 and the astigmatism plates 152, 153, laser light directed from the collimator lens 105 in plus X-axis direction is converged in a flat surface direction and in a curved surface direction in the same manner as the inventive example. Thus, substantially the same astigmatism as in the inventive example is imparted, and substantially the same effect as in the inventive example is provided. In this modification example, the inexpensive half mirror 151 and astigmatism plates 152, 153 are used, in place of the PBS 104 and the anamorphic lens 112 used in the inventive example. This is advantageous in suppressing the cost required for the optical pickup device.

As shown in FIG. 12B, the optical system of the optical pickup device may be configured in such a manner that the track tangential direction on the disc is inclined by 45 degrees with respect to X-axis direction. In this case, the direction (the flat surface direction, the curved surface direction) of astigmatism to be imparted by the half mirror 151 is inclined by 45 degrees with respect to the direction of a track image. Accordingly, as shown in FIG. 12B, in the optical system of the optical pickup device in this case, the astigmatism plates 152, 153 may be omitted from the optical system shown in FIG. 12A. Further, the light separating element 111 and the photodetector 113 are rotated about X-axis by 45 degrees from the state shown in FIG. 12A. Adjusting the disposition of the light separating element 111 and the photodetector 113 as described above provides substantially the same effect as in the inventive example. The modified arrangement is advantageous in reducing the number of parts, as compared with the arrangement shown in FIG. 12A.

### Modification Example 4

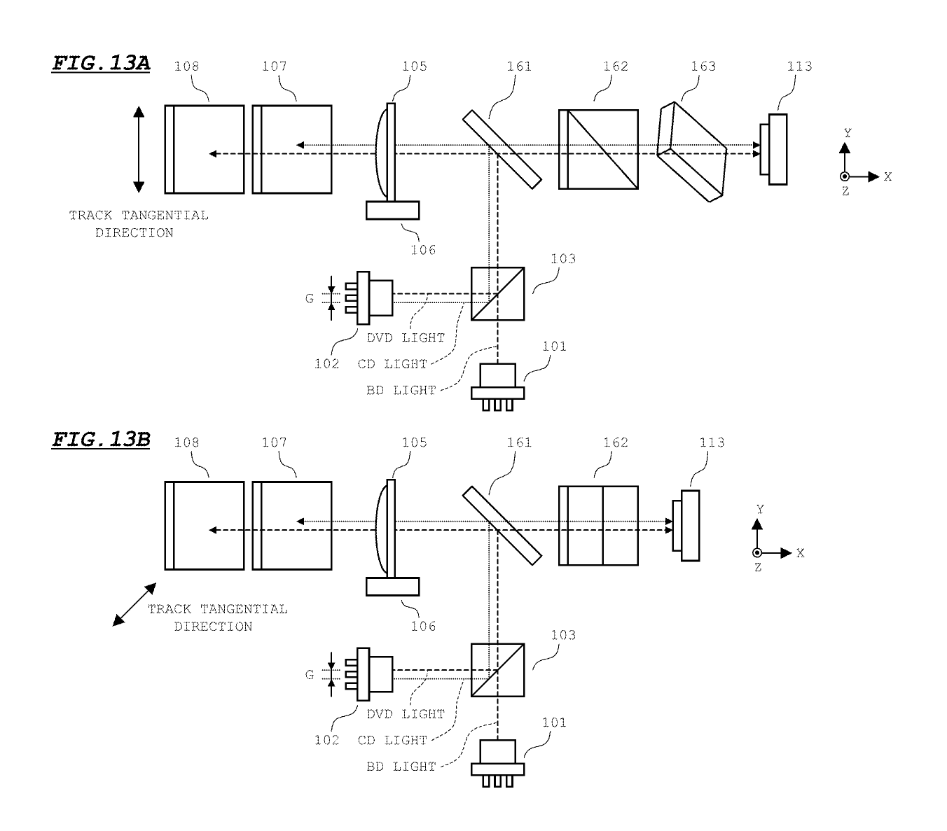

FIG. 13A is a diagram showing a part of an optical system of an optical pickup device in this modification example. The optical system of the optical pickup device in this modification example is configured by disposing a half mirror 161 and astigmatism plates 162, 163 in the optical system of the optical pickup device shown in FIGS. 7A, 7B, in place of the PBS 104, the light separating element 111, and the anamorphic lens 112. The illustration on the elements of the optical system of the optical pickup device in this modification example, on the disc side with respect to the rise-up mirrors 107, 108, is omitted herein to simplify the description.

The half mirror 161 and the astigmatism plates 162, 163 also impart astigmatism to laser light directed from the collimator lens 105 in plus X-axis direction in the same manner as the half mirror 151 and the astigmatism plates 152, 153 described in modification example 3. The astigmatisms by the half mirror 161 and the astigmatism plate 162 are adjusted to such values that the astigmatisms are substantially cancelled out each other. Accordingly, only the effect of astigmatism by the astigmatism plate 163 remains. The astigmatism plate 163 has substantially the same arrangement as the astigmatism plate 153 in modification example 3. Similarly to the astigmatism plate 153 in modification example 3, the astigmatism plate 163 is operable to suppress coma aberrations generated by the half mirror 161 and the astigmatism plate 162.

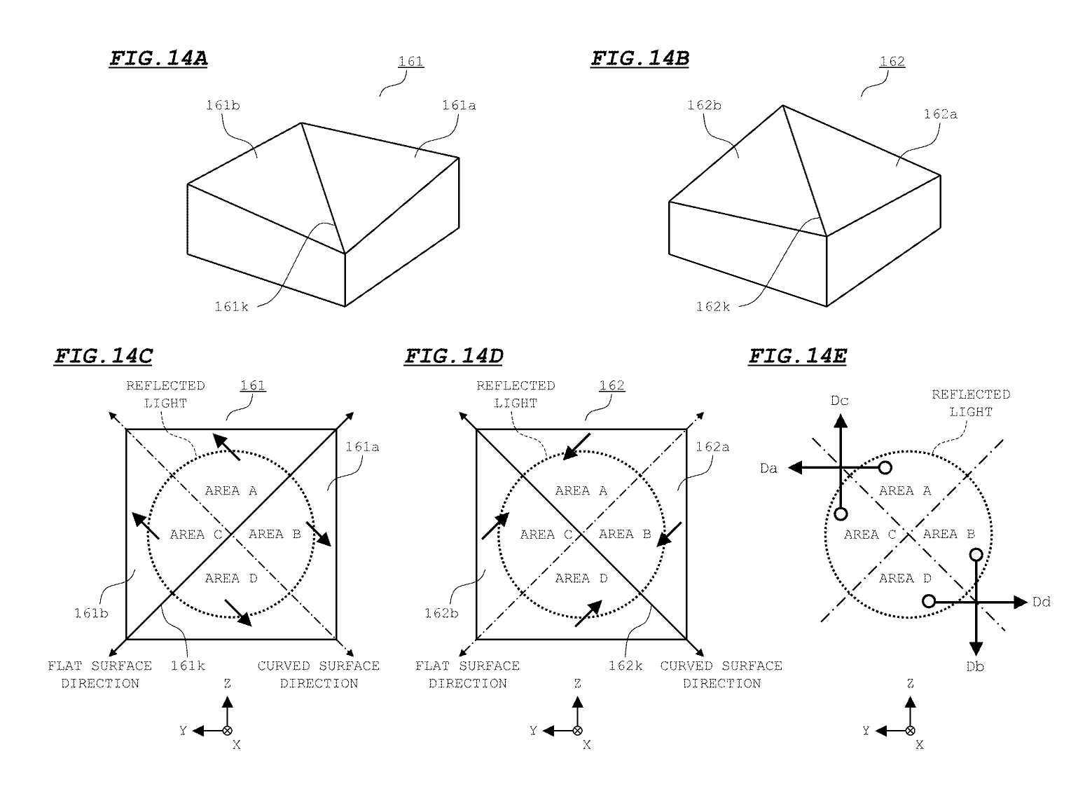

FIGS. 14A, 14B are perspective views respectively showing arrangements of the half mirror 161 and the astigmatism plate 162. FIGS. 14C, 14D are diagrams respectively schematically showing how the propagating direction of laser light is changed by the half mirror 161 and the astigmatism plate 162. FIGS. 14C, 14D are schematic diagrams of the half mirror 161 and the astigmatism plate 162 arranged as shown in FIG. 13A, when viewed from plus X-axis direction.

As shown in FIG. 14A, two different slopes 161a, 161b having a valley shape are formed on the output surface of the half mirror 161. Further, as shown in FIG. 14B, two different slopes 162a, 162b having a hill shape are formed on the output surface of the astigmatism plate 162. A line of intersection 161k of the slopes of the half mirror 161 is aligned with the flat surface direction shown in FIG. 7B. Further, a line of intersection 162k of the slopes of the astigmatism plate 162 is aligned with the curved surface direction shown in FIG. 7B.

As shown in FIGS. 14C, 14D, light fluxes on light flux areas A through D formed by dividing reflected light to be entered into the half mirror 161 by two straight lines in parallel to the flat surface direction and the curved surface direction are entered into the slopes 161a, 161b of the half mirror 161, and into the slopes 162a, 162b of the astigmatism plate 162. With this arrangement, the propagating directions of the light fluxes on the light flux areas A through D are changed into the directions of arrows by the slopes 161a, 161b and the slopes 162a, 162b. Thus, the light fluxes on the light flux areas A through D respectively have the propagating directions thereof changed into directions Da through Da shown in FIG. 14E by transmission through the half mirror 161 and the astigmatism plate 162. In this example, the directions Da through Dd shown in FIG. 14E correspond to the directions Da through Dd shown in FIG. 4A.

As described above, the propagating directions of light fluxes of reflected light passing through the light flux areas A through D are changed by the half mirror 161 and the astigmatism plate 162. Further, astigmatism is imparted to the light fluxes of reflected light by the half mirror 161 and the astigmatism plates 162, 163 in the same manner as in modification example 3. Thus, this modification example provides substantially the same effect as in the inventive example.

Further, in this modification example, the light separating element 111 is not used, unlike modification example 3. This is advantageous in further suppressing the cost required for the optical pickup device. Further, in this modification example, the number of parts constituting the optical pickup device is reduced, as compared with modification example 3. This is advantageous in further miniaturizing the optical pickup device.

Alternatively, as shown in FIG. 13B, the optical system of the optical pickup device may be configured in such a manner that the track tangential direction on the disc is inclined by 45 degrees with respect to X-axis direction. In the optical system of the optical pickup device in this case, as shown in FIG. 13B, the astigmatism plate 163 is omitted from the optical system shown in FIG. 13A. Further, the photodetector 113 is rotated about X-axis by 45 degrees from the state shown in FIG. 13A.

In the arrangement shown in FIG. 13B, astigmatism is imparted to laser light individually by the half mirror 161 and the astigmatism plate 162. Specifically, laser light is converged in Y-axis direction by the half mirror 161 for imparting astigmatism. Further, laser light is converged in Z-axis direction by the astigmatism plate 162 for imparting astigmatism. If convergence by the half mirror 161 and convergence by the astigmatism plate 162 are equal to each other, astigmatism is not generated. In view of the above, in this arrangement, the half mirror 161 and the astigmatism plate 162 are so configured as to make convergence by the half mirror 161 and convergence by the astigmatism plate 162 different from each other.

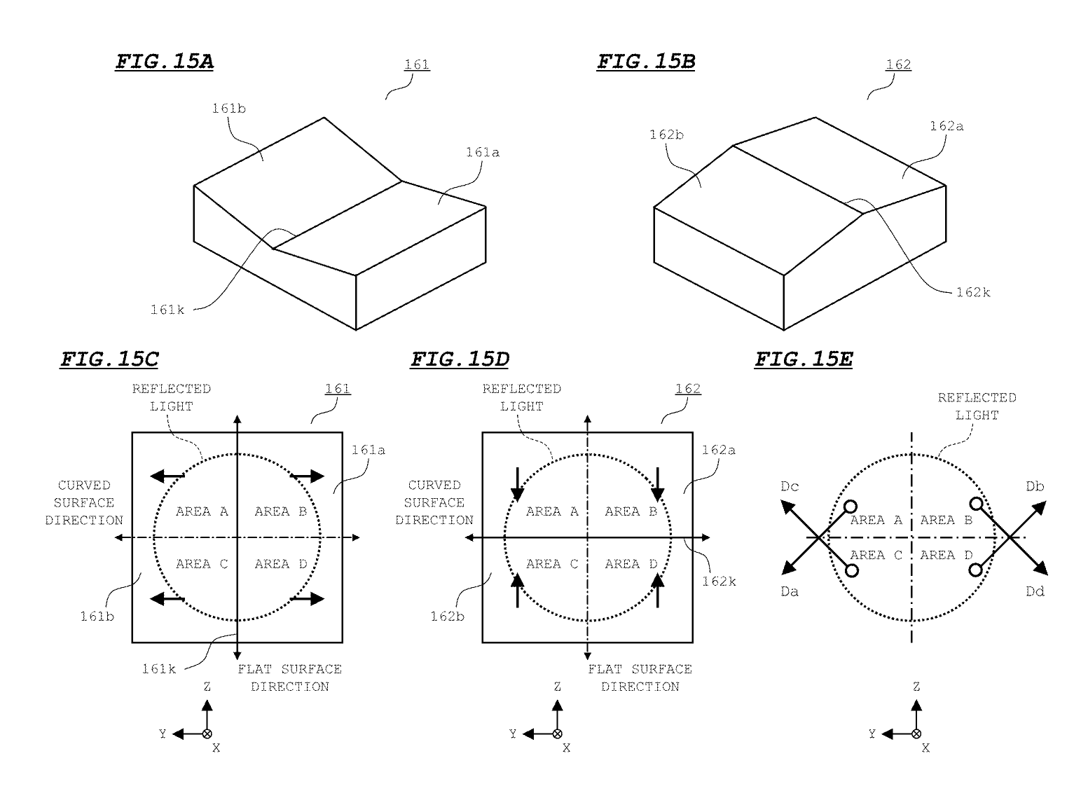

In the arrangement example shown in FIG. 13B, as shown in FIGS. 15A, 15B, each of the half mirror 161 and the astigmatism plate 162 has two slopes. Further, as shown in FIGS. 15C, 15D, the half mirror 161 and the astigmatism plate 162 in this case are disposed at such positions that the line of intersection 161k of the half mirror 161 is aligned in parallel to Z-axis direction and that the line of intersection 162k of the astigmatism plate 162 is aligned in parallel to Y-axis direction. With this arrangement, as shown in FIG. 15E, light flux areas of reflected light are separated from each other in directions displaced from the flat surface direction and the curved surface direction by 45 degrees. Thus, this modification example provides substantially the same effect as in the inventive example.

The example of the invention has been described as above. The invention is not limited to the foregoing example, and the example of the invention may be modified in various ways other than the above.

For instance, in the inventive example and in modification example 1, the light separating element 111 is disposed anterior to the anamorphic lens 112. Alternatively, the light separating element 111 may be disposed posterior to the anamorphic lens 112. Further, as shown in FIG. 12A, in modification example 3, the astigmatism plates 152, 153 and the light separating element 111 are arranged in this order along the propagating direction of reflected light. Alternatively, the order of arranging these elements may be changed, as necessary. Further, as shown in FIG. 13A, in modification example 4, the astigmatism plates 162, 163 are arranged in this order along the propagating direction of reflected light. Alternatively, the order of arranging these elements may be changed, as necessary.

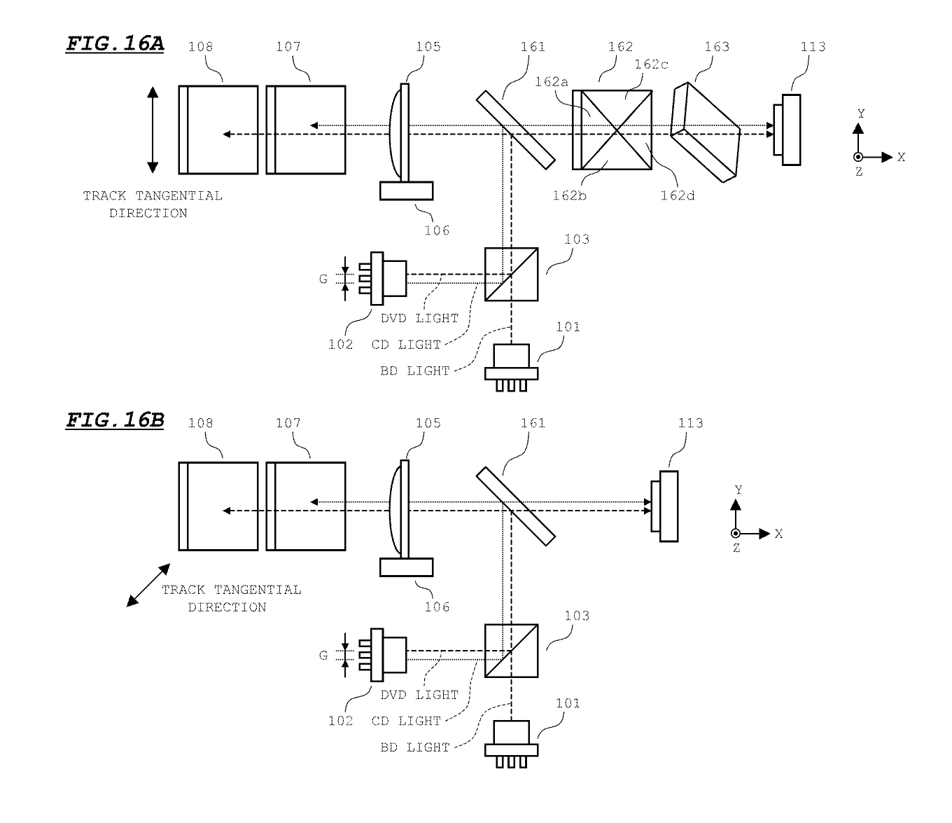

Further, as shown in FIG. 13A, in modification example 4, a light separating function is provided to the half mirror 161 and the astigmatism plate 162. Alternatively, a light separating function maybe provided to at least one of the half mirror 161 and the astigmatism plates 162, 163. For instance, a light separating function may be provided to the half mirror 161 and the astigmatism plate 163, or to the astigmatism plates 162, 163, or to either one of the half mirror 161 and the astigmatism plates 162, 163. For instance, as shown in FIG. 16A, a light separating function may be provided only to the astigmatism plate 162. In this case, the output surface of the astigmatism plate 162 is formed with slopes 162a through 162d corresponding to the slopes 111a through 111d shown in FIG. 8A.

In the above case, the inclination angles of the four slopes 162a through 162d formed on the output surface of the astigmatism plate 162 are different from those shown in FIG. 8A. Specifically, in the arrangement of the inventive example shown in FIG. 7A, the light separating element 111 is disposed perpendicular to the optical axis of laser light. In the arrangement shown in FIG. 16A, the astigmatism plate 162 is disposed with an inclination with respect to the optical axis of laser light. Accordingly, the inclination angles of the four slopes 162a through 162d formed on the output surface of the astigmatism plate 162 are set, taking into account the inclination of the astigmatism plate 162. In this point, the inclination angles of the four slopes 162a through 162d formed on the output surface of the astigmatism plate 162 are different from those shown in FIG. 8A.

Also, in the case shown in FIG. 13B, a light separating function maybe provided to at least one of the half mirror 161 and the astigmatism plate 162. In the case where a light separating function is provided only to the half mirror 161, the astigmatism plate 162 maybe omitted. Specifically, in the arrangement example shown in FIG. 13B, the astigmatism plate 162 is disposed, because a light separating function is shared by both the half mirror 161 and the astigmatism plate 162. However, in the case where a light separating function is provided only to the half mirror 161, the astigmatism plate 162 contributes only to adjustment of astigmatism. In view of the above, in the case where there is no need of adjusting astigmatism by the astigmatism plate 162, in other words, in the case where astigmatism is imparted to laser light only by using astigmatism of the half mirror 161, the astigmatism plate 162 is omitted.

FIG. 16B is a diagram showing an optical system, in which alight separating function is provided only to the half mirror 161 in the optical system shown in FIG. 13B. In this case, four different slopes as shown in FIG. 8A are formed on the output surface of the half mirror 161, and the boundary portions of these slopes are aligned with Y-axis direction or Z-axis direction. With this arrangement, substantially the same light separating function as in the case shown in FIG. 13B is provided. Further, in this case, reflected light from the collimator lens 105 toward X-axis direction is convergent light, and the track tangential direction is inclined by 45 degrees with respect to X-axis. Accordingly, substantially the same astigmatism as in the case shown in FIG. 13B is imparted only by the half mirror 161.

Also, in the above case, the inclination angles of four different slopes formed on the output surface of the half mirror 161 are different from those in the case shown in FIG. 8A in the same manner as the arrangement of the astigmatism plate 162 described referring to FIG. 16A. Specifically, whereas, in the arrangement of the inventive example shown in FIG. 7A, the light separating element 111 is disposed perpendicular to the optical axis of laser light, in the arrangement shown in FIG. 16B, the half mirror 161 is inclined with respect to the optical axis of laser light. In view of the above, the inclination angles of the four different slopes formed on the output surface of the half mirror 161 are set, taking into account the inclination of the half mirror 161.

Further, in this modification example, as shown in FIG. 12B, 13B, 16B, in the case where the track tangential direction is inclined by 45 degrees with respect to X-axis, a single objective lens corresponding to BD light, DVD light, CD light may be used, in place of the dual wavelength objective lens 109 and the BD objective lens 110. This enables to move the objective lens in the disc radial direction, in all the cases where BD light, DVD light, CD light is used.

The embodiment of the invention may be changed or modified in various ways as necessary, as far as such changes and modifications do not depart from the scope of the claims of the invention hereinafter defined.

What is claimed is:

1. An optical pickup device, comprising:
a first laser light source which emits first laser light of a predetermined wavelength;
a second laser light source which emits second laser light of a wavelength different from the wavelength of the first laser light;
an optical element which aligns optical axes of the first and second laser light with each other;
an objective lens portion which focuses the first and second laser light on a recording medium;
an astigmatism portion into which reflected light of the first and second laser light reflected on the recording medium is entered, and which generates a first focal line by converging the reflected light in a first direction and generates a second focal line by converging the reflected light in a second direction perpendicular to the first direction;
a light separating portion which separates light fluxes of the reflected light of the first and second laser light from each other, the light fluxes being obtained by dividing the reflected light of the first and second laser light into four light fluxes by two straight lines respectively in parallel to the first and second directions; and
a photodetector which receives the separated light fluxes of the reflected light of the first and second laser light to output a detection signal, wherein
the light separating portion is constituted of at least one prism having a plurality of slopes, and
the photodetector is provided with a common sensor portion which receives the light fluxes of the reflected light of the first laser light, and the light fluxes of the reflected light of the second laser light.

2. The optical pickup device according to claim 1, wherein
the optical element is constituted of a dichroic mirror which transmits the first laser light emitted from the first laser light source, and reflects the second laser light emitted from the second laser light source.

3. The optical pickup device according to claim 1, wherein
the light separating portion changes a propagating direction of each of the four light fluxes in such a manner that the separated four light fluxes are respectively guided to positions corresponding to four vertices of a rectangle, on a light receiving surface of the photodetector.

4. The optical pickup device according to claim 1, wherein
the astigmatism portion and the light separating portion are integrally formed.

5. The optical pickup device according to claim 1, wherein
the astigmatism portion includes a light-transmissive flat parallel plate which is disposed obliquely with respect to the optical axes of the reflected light of the first and second laser light.

6. The optical pickup device according to claim 1, wherein
the astigmatism portion includes light-transmissive first and second planar members which are disposed obliquely with respect to the optical axes of the reflected light of the first and second laser light, and
either one or both of the first and second planar members are formed with a slope serving as the light separating portion.
